(19) United States
(12) Patent Application Publication
(10) Pub. No.: US 2010/0191866 A1
(43) Pub. Date: Jul. 29, 2010

(54) Information Processing Device, For Controlling The Same Method And Recording Medium

(75) Inventors: Junpei KUROGI, Matsumoto-shi (JP); Masayasu IWANAMI, Suwashi (JP); Makoto ONO, Nagano-ken (JP); Tomonori ISSHI, Azumino-shi (JP); Kazuhito GASSHO, Shiojiri-shi (JP); Hikonosuke UWAI, Azumino-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/683,329

(22) Filed: Jan. 6, 2010

(30) Foreign Application Priority Data
Jan. 26, 2009 (JP) 2009-014074

(51) Int. Cl. G06F 3/00

(52) U.S. Cl. 710/5

(57) ABSTRACT

An information processing device that is connected to external devices includes a receiving unit that receives a command from the external devices, a judgment unit that determines whether the command received by the receiving unit is a first type command that reads out, rewrites, or deletes data stored in the information processing device, or a second type command other than the first type command, and a command processing unit in which execution of the command received by the receiving unit is prohibited when the command is the first type command, and execution of the command received by the receiving unit is performed when the command is the second type command, in accordance with determination by the judgment unit.

### BACKGROUND

1. Technical Field

The present invention relates to a printer, an information processing device with a built-in printer or the like, a method for controlling the device, and a computer-readable recording medium that stores a computer program.

2. Related Art

Printers as an information processing device, or multifunction peripherals having functions such as printing, scanning, and facsimile functions are usually provided with various security functions. Examples of such security functions include a function that blocks specific inputs and a function that restricts which users can access the machine.

Since, as described above, the information processing devices are usually provided with these functions that block specific inputs and restrict which users can access the machine as security functions, the available functions and users are limited. Therefore, while security was sufficiently secured, the device lacked versatility because of the strong limitations, that was a problem.

Even when the device is subject to the limitations described above, if a print job includes a restricted command such as a command for reading device information or rewriting device settings, those commands are sometimes embedded in a received job, and there is no method to avoid executing the command.

In other words, if the above-mentioned command is received, the printer executes the command, and therefore even though the printer is provided with the above-mentioned security functions, these functions cannot be performed.

### SUMMARY

An advantage of some aspects of the invention is to provide an information processing device, a control method, and a program which can improve its usability while securing security.

An information processing device, which is connected to external devices, according to an aspect of the invention includes a receiving unit that receives a command from the external devices, a judgment unit, and a command processing unit. The judgment unit determines whether the command received by the receiving unit is a first type command or a second type command other than the first type command. The first type command executes read-out, rewrite, or deletion of data stored in the information processing device. The command processing unit prohibits execution of the command received by the receiving unit when the command is the first type command, and executes the command received by the receiving unit when the command is the second type command, in accordance with determination by the judgment unit.

Thus, as execution of the first type command is prohibited, read-out, rewrite, or deletion of data stored in the information processing device is prohibited, so that the data stored in the information processing device is protected.

It is preferable that the information processing device perform in a first type command prohibit mode in which execution of the first type command is prohibited, and the judgment unit perform determination of the received command when the device is in the first type command prohibit mode.

Thereby, execution of the first type command is prohibited only when the device is in the first type command prohibit mode, while the first type command can be executed when the device is not in the first type command prohibit mode.

It is preferable that the information processing device have a plurality of receiving units and enter the first type command prohibit mode when one of predetermined receiving units received the command.

It is preferable that the information processing device enter the first type command prohibit mode when the receiving unit receives a data file in a predetermined format.

It is preferable that the information processing device enter the first type command prohibit mode when the receiving unit received a command sent from a predetermined source.

It is preferable that the information processing device be a printer, and when the receiving unit received a print job containing a plurality of commands, the judgment unit may perform determination of whether each of the plurality of commands is the first type command or the second type command.

Thereby, when a print job containing a plurality of commands is received, the judgment unit performs determination of whether each command in the printer job is the first type command or the second type command, so that if the print job contains a first type command, execution of the first type command can be prohibited, and the second type command can only be executed.

### BRIEF DESCRIPTION OF THE DRAWINGS

The invention will be described with reference to the accompanying drawings, wherein like numbers reference like elements.

FIG. 1 is a configuration diagram of a system in which a printer as an information processing device according to an embodiment of the invention is connected to external devices.

FIG. 2 is a detailed block diagram of the printer of FIG. 1.

FIG. 3 is a decision table of conditions for whether or not judgment is necessary for external-commands.

FIG. 4 is a flowchart of command processing procedure executed by the printer of FIG. 2.

### DESCRIPTION OF EXEMPLARY EMBODIMENTS

An embodiment of the invention will be hereinafter described with reference to the drawings.

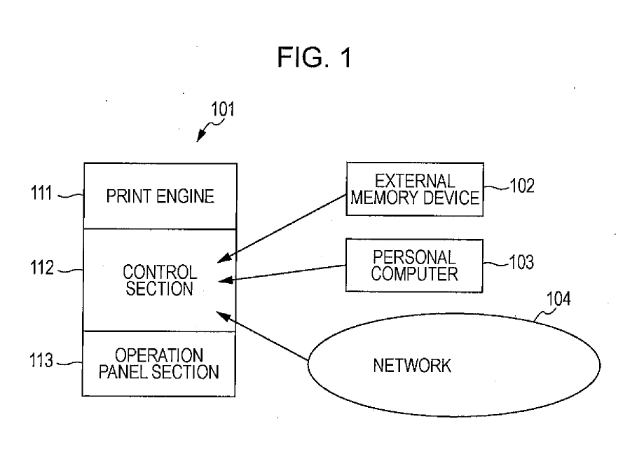

FIG. 1 is a configuration diagram of a printer as an information processing device according to the embodiment of the invention and an external system connected to the printer.

As shown in the drawing, the printer 101 includes a print engine 111, a control section 112, and an operation panel section 113. The printer 101 is connected to, for example, an external memory device 102, a personal computer 103, and a network 104.

The printer 101 receives external control commands (hereinafter simply referred to as “command”), and executes the received commands or prohibits the execution of the received commands depending on the type of the commands.

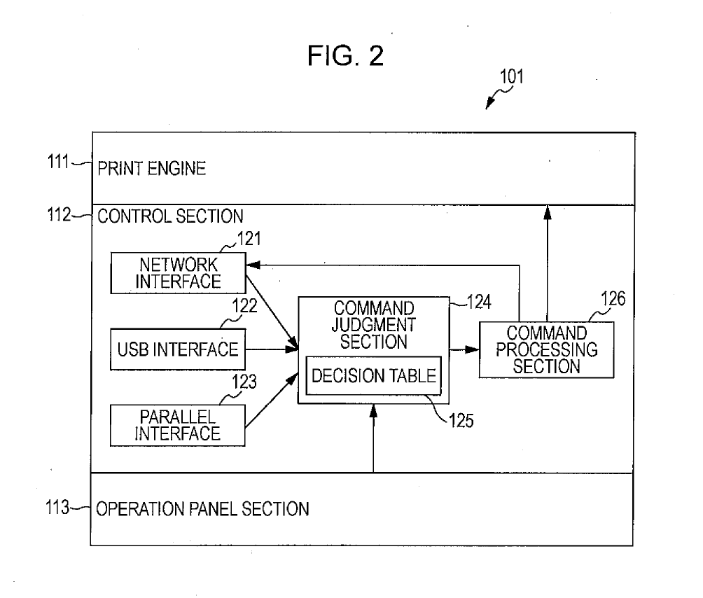

FIG. 2 is a detailed block diagram of the printer of FIG. 1.

The control section 112 is constituted by a computer system that includes a processor and a memory. Functions of individual components of the control section 112 described below can be achieved by executing a computer program.

In the drawing, the control section 112 in the printer 101 includes a network interface 121, a USB (Universal Serial Bus) interface 122 for a USB host controller and the like, a parallel interface 123, a command judgment section 124 having a decision table 125, and a command processing section 126 that executes commands.

In the printer 101, the network interface 121, USB interface 122, parallel interface 123, and operation panel section 113 function as receiving units that receive external commands. For example, the network interface 121, USB interface 122, and parallel interface 123 receive respective commands from external devices such as other computers. The operation panel section 113 receives commands input by a user. For example, the network interface 121, USB interface 122, and parallel interface 123 receive a print job containing a plurality of commands from other computers and the like.

Here, commands received in this embodiment are classified into two types, first type commands and second type commands.

The first type commands are commands that read out, rewrite, or delete certain data which are necessarily protected and stored in the printer 101. The second type commands are commands other than the first type commands. Methods of Reading out protected data include displaying the protected data to the operation panel section 113, printing out the data with the print engine 111, and outputting data externally through the network interface 121, USB interface 122, and parallel interface 123. The protected data also include MIB (Management Information Base) data, firmware, and information for various printer settings.

The command judgment section 124 is a judgment unit that determines whether the command received by the receiving unit is a first type command or a second type command. When a print job includes a plurality of commands, the command judgment section 124 determines whether each of the commands is a first type command or a second type command.

The command processing section 126 is a command processing unit, that prohibits or executes commands in accordance with the determination by the judgment unit. When the command received by the receiving unit is a first type command, the command processing section prohibits execution of that command, when the command received by the receiving unit is a second type command, the command processing section executes the command. That is, the command processing section 126 executes only second type commands and does not execute (i.e., ignores) first type commands.

The printer 101 may perform in a first type command prohibit mode for prohibiting execution of first type commands. That is, when the printer 101 is in the first type command prohibit mode, the command processing section 126 prohibits execution of the first type commands as described above. When the printer 101 is not in the first type command prohibit mode, the command processing section 126 allows execution of the above-described first type commands.

The printer 101 may also be configured such that it enters the first type command prohibit mode when the operation panel section 113 is operated using a predetermined a specific operation button and the like by a user (administrator). Alternatively, the printer may be configured such that the printer 101 enters the first type command prohibit mode when one of predetermined receiving units received a command. For example, the printer may enter the first type command prohibit mode when any of the network interface 121, USB interface 122, and parallel interface 123 receive(s) a command.

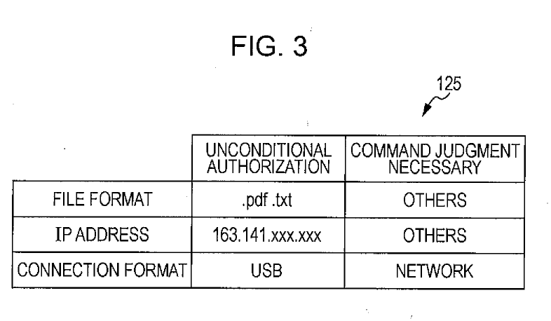

FIG. 3 shows an example of a decision table 125 for conditions whether or not judgment is necessary. Whether an externally input command is the first type command or not is determined. As described above, the data of this decision table 125 is stored in the command judgment section 124.

The decision table 125 is a table used for determining whether or not it is necessary to judge whether the command is the first type command or the second type command, depending respectively on file format, IP address, and connection format.

For example, in the case of FIG. 3, if the data format of the command is either in a PDF file format (with the extension “.pdf”) or in a text file format (with the extension “.txt”), “unconditional authorization” is given, i.e., the command judgment section 124 does not perform command judgment. That is, when the command is in file formats that fall under this “unconditional authorization” category, the command processing section 126 executes the command unconditionally.

Similarly, referring to FIG. 3, when the source IP address of the command is “163.141.xxx.xxx”, “unconditional authorization” is given. This enables, for example, an input received by the network interface 121 that is sent from a specified IP address (such as a specific in-house department) alone to be unconditionally authorized, while inputs from other IP addresses are subjected to command judgment.

The drawing further shows that “unconditional authorization” is given when the connection format (receiving unit) is a USB interface. This allows print jobs input from a USB interface to be executed unconditionally.

The content of the decision table 125 may be suitably set. For example, specific file formats, command sources, and connection formats may be designated as falling under the “unconditional authorization” category while those other than the specified parameters are set under “command judgment necessary”. Conversely, specific file formats, command sources, and connection formats may be designated as falling under the “command judgment necessary” category while those other than the specified parameters are set under “unconditional authorization”.

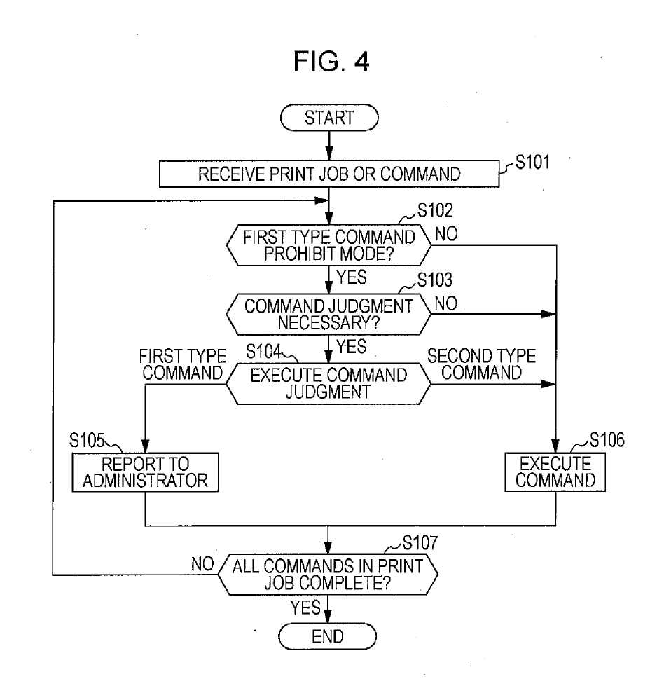

The above processing procedures are summarized as a flowchart in FIG. 4.

FIG. 4 is a flowchart of command processing procedure executed by the printer of FIG. 2.

Referring to FIG. 4, first, the control section 112 receives a print job containing one or more commands (S101). Next, the control section 112 determines whether or not the printer 101 is in the first type command prohibit mode (S102). In this determining process, in addition to judging whether or not the printer has already entered the first type command prohibit mode, it may be determined whether or not an input is received by a receiving unit that has previously been designated to cause the printer to enter the first type command prohibit mode. When the receiving unit that has previously been designated to cause the printer to enter the first type command prohibit mode received a command, the printer enters the first type command prohibit mode.

If the printer is in the first type command prohibit mode (S102: Yes), the command judgment section 124 determines whether or not command judgment is necessary (S103) on the basis of the decision table 125 of FIG. 3.

When the input received at process S101 has any of the file format, IP address, and connection format classified under the category of “command judgment necessary” in the decision table 125 of FIG. 3 (S103: Yes), then the command judgment section 124 performs judgment of whether the command is a first type command or a second type command (S104), with respect to each of the commands received at process S101.

When the command judgment section 124 determines that the command is a first type command (S104: first type command), the command processing section 126 does not execute that command and instead indicates to the administrator (S105), for example, by displaying an alert in the operation panel section 113.

In the cases when the printer 101 is not in the first type command prohibit mode at process 5102 (S102: No); when it is determined that no command judgment is necessary at process S103 (S103: No); and when the command judgment section 124 determines that the command is a second type command at process S104 (S104: second type command), the flow goes to process S106, where the command processing section 126 executes the command received at process S101 (S106).

Following processes S105 and S106, the above-described processes of S102 to S106 are repeated until these processes are all complete with respect to all of the commands received at process S101 (S107). The flowchart ends when the processes S102 to S106 are all complete with respect to all of the received commands.

According to this embodiment, execution or prohibition of first type commands that are for accessing the protected data can be controlled. This allows the printer according to this embodiment to be improved in usability while security is secured.

The above-described embodiment of the invention is shown for illustration purpose only of the invention and should not be understood as limiting the scope of the invention to the specific embodiment. It will be apparent for those skilled in the art that the invention may be embodied in various other manners without departing from the subject matter of the invention.

For example, though a printer is described as an example of the information processing device in the above described embodiment, the embodiment of the invention may be applied to other equipment with a built-in information processing device such as facsimile machines, scanners, multifunction machines, digital cameras, mobile phones other than printers.

The entire disclosure of Japanese Patent Application No. 2009-014074, filed Jan. 26, 2009 is expressly incorporated by reference herein.

What is claimed is:

1. An information processing device that is connected to external devices, comprising:
a receiving unit that receives a command from the external devices;
a judgment unit that determines whether the command received by the receiving unit is a first type command that reads out, rewrites, or deletes data stored in the information processing device, or a second type command other than the first type command; and
a command processing unit in which execution of the command received by the receiving unit is prohibited when the command is the first type command, and execution of the command received by the receiving unit is performed when the command is the second type command, in accordance with determination by the judgment unit.

2. The information processing device according to claim 1, wherein the information processing device performs in a first type command prohibit mode in which execution of the first type command is prohibited, and wherein the judgment unit performs determination of the command when the device is in the first type command prohibit mode.

3. The information processing device according to claim 2, wherein the information processing device has a plurality of receiving units and wherein the device enters the first type command prohibit mode when one of predetermined receiving units received the command.

4. The information processing device according to claim 2, wherein the information processing device enters the first type command prohibit mode when the receiving unit received a data file in a predetermined format.

5. The information processing device according to claim 2, wherein the information processing device enters the first type command prohibit mode when the receiving unit received a command sent from a predetermined source.

6. The information processing device according to claim 1, wherein the information processing device is a printer, and when the receiving unit received a print job containing a plurality of commands, the judgment unit performs determination of whether each of the plurality of commands is the first type command or the second type command.

7. A method for controlling an information processing device connected to external devices, the method comprising:
receiving an external command;
determining whether the command received at the receiving process is a first type command that reads out, rewrites, or deletes data stored in the information processing device, or a second type command other than the first type command; and
processing the command in accordance with a determination result obtained by the determining process such that execution of the command received at the receiving process is prohibited when the command is the first type command, and execution of the command received at the receiving process is performed when the command is the second type command.

8. A computer-readable recording medium that stores a computer program for controlling an information processing device that is connected to external devices, wherein the computer program causes the information processing device to perform processes, the processes comprising:
receiving an external command;
determining whether the command received at the receiving process is a first type command that reads out, rewrites, or deletes data stored in the information processing device, or a second type command other than the first type command; and
processing the command in accordance with a determination result obtained by the determining process such that execution of the command received at the receiving process is prohibited when the command is the first type command, and execution of the command received at the receiving process is performed when the command is the second type command.
